(19) United States
(12) Patent Application Publication
(10) Pub. No.: US 2005/0127299 A1
(43) Pub. Date: Jun. 16, 2005

(54) Apparatus for checking a laser processed deteriorated layer

(76) Inventors: Yusuke Nagai, Tokyo (JP); Satoshi Kobayashi, Tokyo (JP); Yukio Morishige, Tokyo (JP); Masaru Nakamura, Tokyo (JP); Masahiro Murata, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 11/004,818

(22) Filed: Dec. 7, 2004

(30) Foreign Application Priority Data
Dec. 16, 2003 (JP) 2003-417869

(51) Int. Cl. G03B 27/42

(52) U.S. Cl. 250/358.1

(57) ABSTRACT

An apparatus for checking a laser processed deteriorated layer formed in the inside of a workpiece by applying a laser beam capable of passing through the workpiece to the workpiece, comprising a workpiece holding means for holding the workpiece; a light application means for applying light capable of passing through the workpiece held on the workpiece holding means to the exposed surface of the workpiece at a predetermined angle; a light receiving means for receiving light that is applied from the light application, passes through the inside of the workpiece and is reflected from the workpiece; and a display means for displaying the state of light received by the light receiving means.

### FIELD OF THE INVENTION

The present invention relates to an apparatus for checking a deteriorated layer formed in the inside of a workpiece along a dividing line by applying a laser beam capable of passing through the workpiece along the dividing line formed on the workpiece.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer, and a circuit such as IC, LSI or the like is formed in each of the sectioned areas. Individual semiconductor chips are manufactured by cutting this semiconductor wafer along the dividing lines to divide it into the areas in which the circuits are formed. An optical device wafer comprising gallium nitride-based compound semiconductors formed on the front surface of a sapphire substrate is also cut along dividing lines to be divided into individual optical devices such as light emitting diodes or laser diodes, and these devices are widely used in electric equipment.

Cutting along the dividing lines of the above semiconductor wafer or optical device wafer is generally carried out by a cutting machine called “dicer”. This cutting machine comprises a chuck table for holding a workpiece such as a semiconductor wafer or optical device wafer, a cutting means for cutting the workpiece held on the chuck table, and a cutting-feed means for moving the chuck table and the cutting means relative to each other. The cutting means has a spindle unit which comprises a rotary spindle, a cutting blade mounted to the spindle and a drive mechanism for rotary-driving the rotary spindle. The cutting blade comprises a disk-like base and an annular cutting edge which is mounted to the side wall periphery portion of the base and formed as thick as about 20 μm by fixing diamond abrasive grains having a diameter of about 3 μm to the base by electroforming.

Since a sapphire substrate, silicon carbide substrate, etc. have high Mohs hardness, cutting with the above cutting blade is not always easy. Further, since the cutting blade has a thickness of about 20 μm, the dividing lines for sectioning devices must be as thick as about 50 μm. Therefore, in the case of a device measuring about 300 μm×300 μm, the area occupied by the dividing lines is large, thereby reducing productivity.

Meanwhile, as a means of dividing a plate-like workpiece such as a semiconductor wafer, a laser beam processing method for applying a pulse laser beam capable of passing through the workpiece with its focusing point set to the inside of the area to be divided is attempted and disclosed by JP-A 2003-88975, for example. In the dividing method using this laser beam processing technique, the workpiece is divided by applying a pulse laser beam of an infrared range capable of passing through the workpiece from one side of the workpiece with its focusing point set to the inside to continuously form deteriorated layers in the inside of the workpiece along the dividing lines and exerting external force along the dividing lines whose strength has been reduced by the formation of the deteriorated layers.

To divide the workpiece having deteriorated layers formed in the inside along the dividing lines without fail by applying a pulse laser beam, the deteriorated layers must be reliably formed at a predetermined position in the inside of the workpiece. However, when a pulse laser beam is applied without positioning the focusing point of the pulse laser beam to the predetermined position in the inside of the workpiece, the deteriorated layers cannot be formed at the predetermined position in the inside of the workpiece. Since the deteriorated layers formed in the inside of the workpiece cannot be checked from the outside, there is a problem that when external force is exerted to the workpiece having no deteriorated layers in the inside along the dividing lines, the workpiece may be broken.

### SUMMARY OF THE INVENTION

It is an object of the present invention to provide an apparatus for reliably checking a laser processed deteriorated layer formed in the inside of a workpiece by applying a laser beam to the workpiece.

To attain the above object, according to the present invention, there is provided an apparatus for checking a deteriorated layer formed in the inside of a workpiece by applying a laser beam capable of passing through the workpiece to the workpiece, comprising:
a workpiece holding means for holding the workpiece;
a light application means for applying light capable of passing through the workpiece held on the workpiece holding means to the exposed surface of the workpiece at a predetermined angle;
a light receiving means for receiving light that is applied from the light application, passes through the inside of the workpiece and is reflected from the workpiece; and
a display means for displaying the state of light received by the light receiving means.

Preferably, the apparatus comprises which comprises a scanning-feed means for moving the light application means, the light receiving means and the workpiece holding means in a predetermined scanning-feed direction relative to one another. Preferably, the light application means irradiates an infrared laser beam.

Since the apparatus for checking a laser processed deteriorated layer according to the present invention is constituted as described above, the deteriorated layer which is formed in the inside of the workpiece and cannot be checked from the outside can be checked without fail.

### BRIEF DESCRIPTION OF THE DRAWINGS

FIG. 1 is a perspective view of an apparatus for checking a laser processed deteriorated layer constituted according to the present invention;

FIG. 2 is a graph showing the transmittances of materials of a semiconductor wafer;

FIG. 3 is a diagram showing the positional relationship between a light application means and a light receiving means provided in the apparatus for checking a laser processed deteriorated layer shown in FIG. 1 and a workpiece;

FIG. 4 is a diagram showing a scanning state by the apparatus for checking a laser processed deteriorated layer shown in FIG. 1;

FIG. 5 is a diagram showing light applied from the light application means and its reflected light;

FIG. 6 is a diagram showing an image of the inside of the workpiece;

FIG. 7 is a perspective view of a semiconductor wafer as the workpiece; and

FIGS. 8(a) and 8(b) are diagrams for explaining laser processing for forming a deteriorated layer in the inside of the semiconductor wafer shown in FIG. 7.

### DETAILED DESCRIPTION OF THE PREFERRED EMBODIMENT

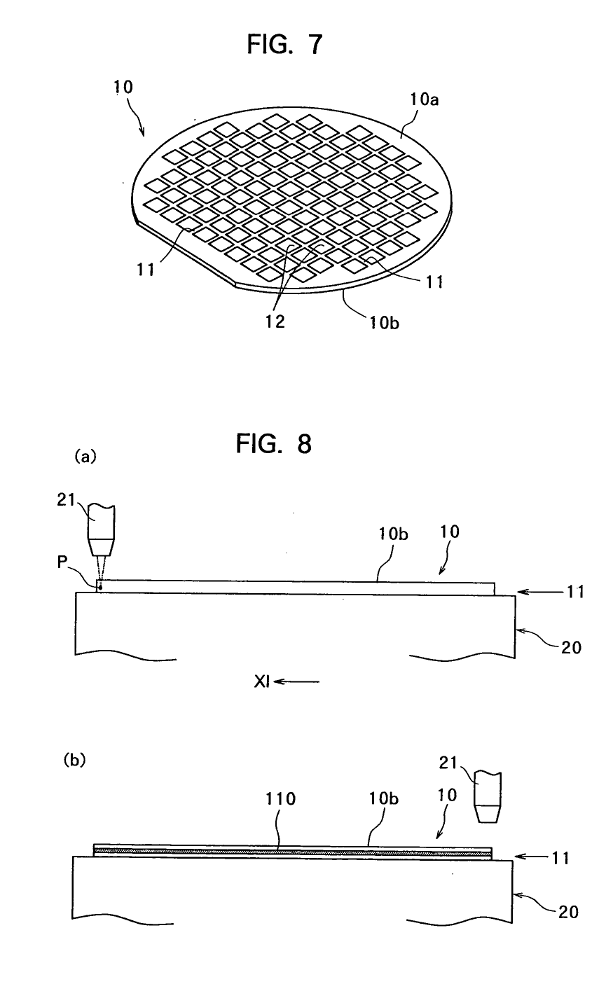

FIG. 7 is a perspective view of a semiconductor wafer 10 comprising a silicon substrate as the workpiece. In the semiconductor wafer 10 shown in FIG. 7, a plurality of dividing lines 11 are formed in a lattice pattern on the front surface 10a, and a circuit 12 such as IC, LSI or the like is formed in each of a plurality of areas sectioned by the plurality of dividing lines 11. The laser processing method for forming a deteriorated layer in the inside of the semiconductor wafer 10 along the dividing line 11 will be described with reference to FIGS. 8(a) and 8(b).

To form the deteriorated layer in the inside of the semiconductor wafer 10 along the dividing line 11, the semiconductor wafer 10 is placed on the chuck table 20 of a laser beam processing machine in such a manner that the back surface 10b faces up and suction-held on the chuck table 20 as shown in FIGS. 8(a) and 8(b). After the semiconductor wafer 10 is suction-held on the chuck table 20, the dividing line 11 is detected from the back surface 10b by an infrared aligning means (not shown), and the chuck table 20 is moved to a laser beam application range where the condenser 21 of laser beam application means for applying a laser beam is located, to bring one end (left end in FIG. 8(a)) of the predetermined dividing line 11 to a position right below the condenser 21 of the laser beam application means as shown in FIG. 8(a). The chuck table 20, that is, the semiconductor wafer 10 is moved in the direction indicated by the arrow X1 in FIG. 8(a) at a predetermined processing-feed rate while a pulse laser beam capable of passing through the semiconductor wafer 10 is applied to the workpiece 10 from the condenser 21. Then, when the application position of the condenser 21 of the laser beam application means reaches the other end (right end in FIG. 8(b)) of the dividing line 11 as shown in FIG. 8(b), the application of the pulse laser beam is suspended, and the movement of the chuck table 20, that is, the semiconductor wafer 10 is stopped. In this laser processing, by setting the focusing point P of the pulse laser beam to a predetermined position in the inside of the semiconductor wafer 10, a deteriorated layer 110 is formed in the inside of the semiconductor wafer 10 along the dividing line 11. This deteriorated layer 110 is formed as a molten-resolidified layer in which the wafer has been once molted and then re-solidified.

The laser processing conditions in the above laser processing are set as follows, for example.
Laser: pulse laser having a wavelength of 1,064 nm
Repetition frequency: 100 kHz
Pulse width: 25 ns
Peak power density: 3.2×10¹⁰ W/cm²
Focusing spot diameter: 1 μm
Processing-feed rate: 100 mm/sec

After the laser processing is carried out along the dividing line 11 in the predetermined direction formed on the wafer 10 as described above, the chuck table 20 or the laser beam application means is indexing-fed a distance corresponding to the interval between the dividing lines 11 in the indexing-feed direction perpendicular to the sheet surface in FIGS. 8(a) and 8(b) to further carry out the above laser processing. After the above laser processing is carried out on all the dividing lines 11 formed in the predetermined direction, the chuck table 20 is turned at 90° to carry out the above laser processing along dividing lines formed in the direction perpendicular to the above predetermined direction subsequently, thereby making it possible to form deteriorated layers 110 in the inside of the semiconductor wafer 10 along all the dividing lines 11. When a low-dielectric insulating film (Low-k film) or test element group (Teg) is not formed on the top surface of the dividing lines 11 formed on the front surface 10a of the semiconductor wafer 10, a pulse laser beam may be applied to the workpiece from the front surface 10a side of the semiconductor wafer 10 to form the deteriorated layers 110.

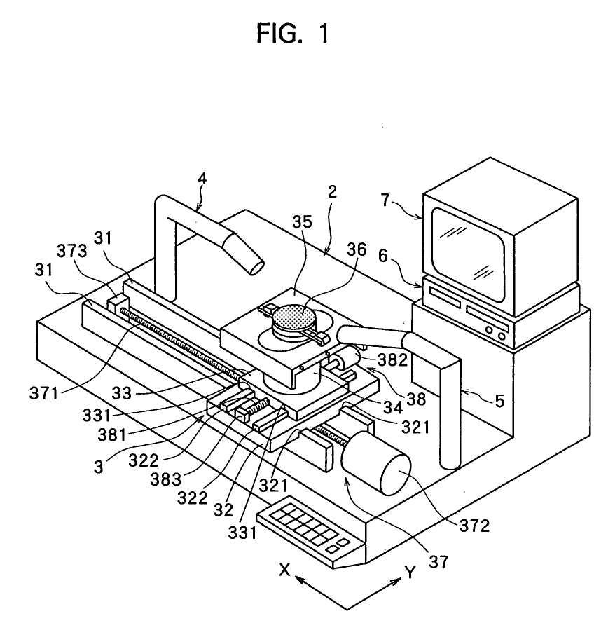

The deteriorated layer 110 formed in the inside of the semiconductor wafer 10 along the dividing line 11 cannot be checked from the outside as described above. Therefore, it is necessary to check whether the deteriorated layer 110 is formed at the predetermined position in the inside of the semiconductor wafer 10 without fail. The apparatus for checking a laser processed deteriorated layer in the inside of the workpiece will be described hereinbelow with reference to FIG. 1.

FIG. 1 is a perspective view of the apparatus for checking a laser processed deteriorated layer constituted according to the present invention. The apparatus for checking a laser processed deteriorated layer shown in FIG. 1 comprises a stationary base 2, a chuck table mechanism 3 for holding a workpiece, which is mounted on the stationary base 2 in such a manner that it can move in a direction indicated by an arrow X, a laser beam application means 4 for applying light capable of passing through a workpiece to the workpiece held on the chuck table mechanism 4, a light receiving means 5 for receiving light, which is applied from the light application means 4, passes through the inside of the workpiece and is reflected from the workpiece, a control means 6 and a display means 7.

The above chuck table mechanism 3 comprises a pair of guide rails 31 and 31 that are mounted on the stationary base 2 and arranged parallel to each other in the direction indicated by the arrow X, a first sliding block 32 mounted on the guide rails 31 and 31 in such a manner that it can move in the direction indicated by the arrow X, a second sliding block 33 mounted on the first sliding block 32 in such a manner that it can move in the direction indicated by the arrow Y, a support table 35 supported on the second sliding block 33 by a cylindrical member 34, and a chuck table 36 as a workpiece holding means. This chuck table 36 is made of a porous material, and a semiconductor wafer as the workpiece is held on the chuck table 36 by a suction means that is not shown. The chuck table 36 is turned by a pulse motor (not shown) installed in the cylindrical member 34. An infrared aligning means (not shown) is arranged above the chuck table 36.

The above first sliding block 32 has, on its undersurface, a pair of to-be-guided grooves 321 and 321 to be fitted to the above pair of guide rails 31 and 31 and has, on its top surface, a pair of guide rails 322 and 322 formed parallel to each other in the direction indicated by the arrow Y. The first sliding block 32 constituted as described above can move in the direction indicated by the arrow X along the pair of guide rails 31 and 31 by fitting the to-be-guided grooves 321 and 321 to the pair of guide rails 31 and 31, respectively. The chuck table mechanism 3 in the illustrated embodiment comprises an indexing-feed means 37 for moving the first sliding block 32 along the pair of guide rails 31 and 31 in the indexing-feed direction indicated by the arrow X. The indexing feed means 37 has a male screw rod 371 arranged between the above pair of guide rails 31 and 31 and in parallel to them, and a drive source such as a pulse motor 372 for rotary-driving the male screw rod 371. The male screw rod 371 is, at its one end, rotatably supported onto a bearing block 373 fixed on the above stationary base 2 and is, at the other end, transmission-coupled to the output shaft of the above pulse motor 372 by a speed reducer that is not shown. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the indexing-feed direction indicated by the arrow X.

The above second sliding block 33 has, on its undersurface, a pair of to-be-guided grooves 331 and 331 to be fitted to the pair of guide rails 322 and 322 on the top surface of the above first sliding block 32 and can move in the scanning-feed direction indicated by the arrow Y by fitting the to-be-guided grooves 331 and 331 to the pair of guide rails 322 and 322, respectively. The chuck table mechanism 3 in the illustrated embodiment comprises a scanning-feed means 38 for moving the second sliding block 33 in the scanning-feed direction indicated by the arrow Y along the pair of guide rails 322 and 322 on the first sliding block 32. The scanning-feed means 38 has a male screw rod 381 which is arranged between the above pair of guide rails 322 and 322 and in parallel to them, and a drive source such as a pulse motor 382 for rotary-driving the male screw rod 381. The male screw rod 381 is, as its one end, rotatably supported onto a bearing block 383 fixed on the top surface of the above first sliding block 32 and is, at the other end, transmission-coupled to the output shaft of the above pulse motor 382 by a speed reducer that is not shown. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the scanning-feed direction indicated by the arrow Y.

The above light application means 4 and the above light receiving means 5 are opposed to each other along the pair of guide rails 31 and 31 of the above chuck table mechanism 3 with the above chuck table 36 interposed therebetween. That is, the light application means 4 and the light receiving means 5 are opposed to each other in the direction perpendicular to the scanning-feed direction indicated by the arrow Y.

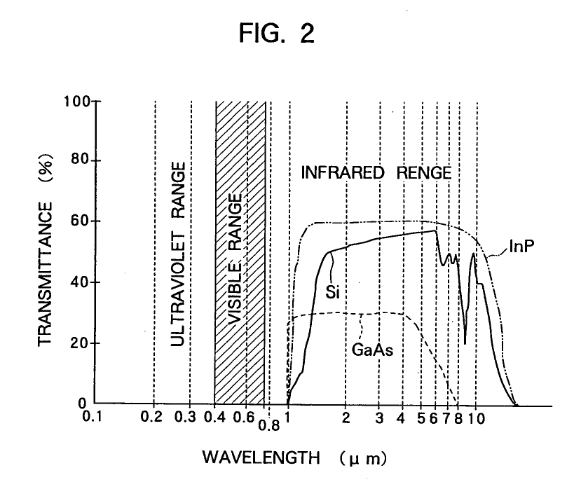

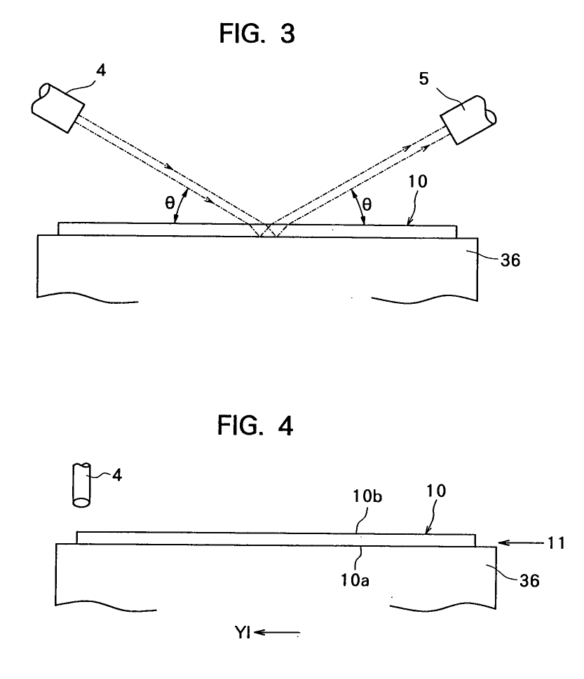

The above light application means 4 is so constituted as to apply light capable of passing through the workpiece. Here, the light capable of passing through the workpiece will be described hereinbelow. FIG. 2 is a graph showing the transmittances of silicon (Si), gallium arsenic (GaAs) and indium (InP) crystals used as the materials of a semiconductor wafer. In the graph, the horizontal axis shows the wavelength of light and the vertical axis shows transmittance. As understood from FIG. 2, all of the above materials have a high transmittance at an infrared range of 1 to 10 μm of the wavelength. Therefore, when the workpiece is made of any one of the above materials, the light application means 4 may be designed to apply infrared radiation or infrared laser beam having a wavelength of 1 to 10 μm. In the illustrated embodiment, the light application means 4 comprises a light source such as a 1.3 μm laser diode or a 1.5 μm laser diode for applying a laser beam having a single wavelength at a spot diameter of 400 μm. The light application means 4 thus constituted applies an infrared laser beam at a predetermined angle θ (10 to 45°) to the exposed surface (top surface) of a wafer 10 as the workpiece held on the chuck table 36 as shown in FIG. 3.

The above light receiving means 5 comprises an infrared image pick-up device (infrared CCD), and its light receiving surface is inclined to form the same angle θ as the angle θ at which an infrared laser beam is applied to the exposed surface (top surface) of the wafer 10 held on the chuck table 36 as shown in FIG. 3. Therefore, an infrared laser beam applied from the above light application means 4 goes into the inside of the wafer 10 as the workpiece, is reflected on the interface (undersurface) and received by the light receiving means 5. The light receiving means 5 that has thus received reflected light of the infrared laser beam applied from the light application means 4 outputs an electric signal corresponding to the intensity of the received light. The electric signal from the light receiving means 5 is sent to the control means 6 shown in FIG. 1. The control means 6 carries out predetermined processing such as image processing, etc. based on the input electric signal, and displays the result of processing on the display means 7.

The apparatus for checking a laser processed deteriorated layer in the illustrated embodiment is constituted above, and its function will be described hereinbelow with reference to FIGS. 1 and 4 to 6.

The semiconductor wafer 10 having deteriorated layers formed in the inside along the dividing lines 11 by laser processing as described above is placed on the chuck table 36 of the checking apparatus shown in FIG. 1 in such a manner that the back surface 10b faces up and suction-held on the chuck table 36. The chuck table 36 suction-holding the semiconductor wafer 10 is detected and aligned by an infrared aligning means (not shown) such that dividing lines 11 formed in a lattice pattern on the semiconductor wafer 10 become parallel to and perpendicular to the indexing-feed direction indicated by the arrow X and the scanning-feed direction indicated by the arrow Y in FIG. 1, respectively. After the semiconductor wafer 10 is suction-held on the chuck table 36, the chuck table 36 is moved to a scanning area shown in FIG. 1 where one end (left end in FIG. 4) of a predetermined dividing line 11 is brought to a position opposed to the light application means 4 as shown in FIG. 4.

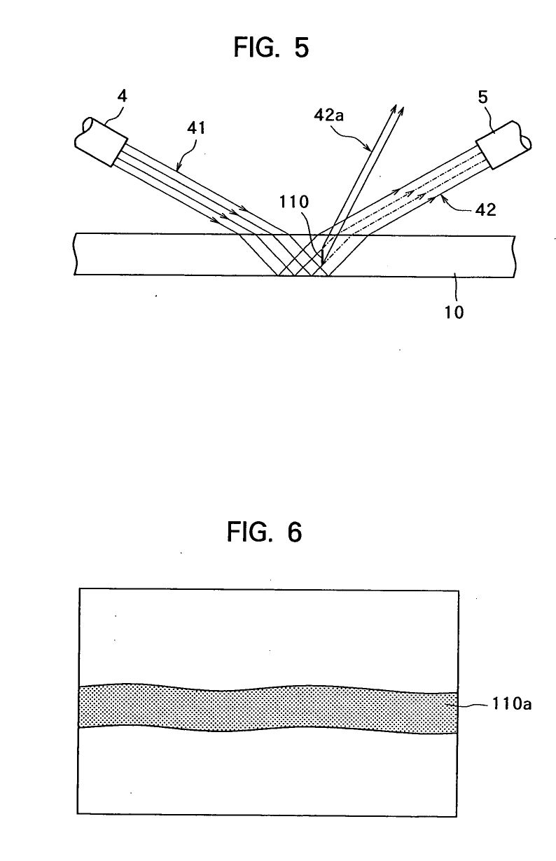

Thereafter, as shown in FIG. 5, an infrared laser beam 41 is applied from the light application means 4 to the semiconductor wafer 10 held on the chuck table 36 at a predetermined incident angle θ, and the scanning-feed means 38 is activated to move the chuck table 36, that is, the semiconductor wafer 10 in the direction indicated by the arrow Y1 in FIG. 4 at a predetermined scanning speed. The infrared laser beam 41 applied from the light application means 4 goes into the inside from the exposed surface (top surface) of the semiconductor wafer 10 and is reflected on the interface (undersurface) as shown in FIG. 5, and the reflected light 42 passes through the inside of the semiconductor wafer 10 and goes out from the exposed surface (top surface) toward the light receiving surface of the light receiving means 5 at a predetermined reflection angle θ. This reflected light 42 is received by the light receiving means 5. However, the reflected light 42a passing through the deteriorated layer 110 formed in the inside of the semiconductor wafer 10 is diffracted. That is, since the deteriorated layer 110 is a molten re-solidified layer as described above, it differs from other portions in crystal structure and diffracts light. Consequently, there is an area where the reflected light 42a passing through the deteriorated layer 110 is not received by the light receiving means 5, and the light receiving means 5 does not receive light in the area shown by a broken line in FIG. 5. Light received by the light receiving means 5 is converted into an electric signal, which is then sent to the control means 6. The control means 6 carries out image processing based on the electric signal from the light receiving means 5 and displays the obtained image on the display means 7.

FIG. 6 shows an example of the image displayed on the display means 7.

In FIG. 6, the area 110a displayed dark shows the above deteriorated layer 110 and the length in the vertical direction of the area 110a displayed dark shows the thickness of the deteriorated layer 110. Thus, it is possible to check whether the deteriorated layer 110 is formed in the inside of the semiconductor wafer 10 or not without fail and also to check the thickness of the deteriorated layer 110. The reason that the area 110a displayed dark in FIG. 6 is curved and not straight is that the deteriorated layer 110 is not formed uniformly at a predetermined position in the thickness direction. As described above, by checking the existence of the deteriorated layer, the thickness of the deteriorated layer and a defect site such as the undulation of the semiconductor wafer or the like, re-processing may be carried out as the case may be and the analysis of the defect can be carried out effectively.

While the present invention has been described as related to the embodiment shown in the accompanying drawings, it is to be understood that various changes and modifications may be made in the invention without departing from the spirit and scope thereof. For example, in the illustrated embodiment, the light receiving means 5 is inclined at the same angle θ as the angle θ at which an infrared layer beam is applied by the light application means 4. The light receiving means 5 may be arranged in the diffraction direction of the infrared laser beam so as to receive the diffracted infrared laser beam.

1. An apparatus for checking a laser processed deteriorated layer formed in the inside of a workpiece by applying a laser beam capable of passing through the workpiece to the workpiece, comprising:
a workpiece holding means for holding the workpiece;
a light application means for applying light capable of passing through the workpiece held on the workpiece holding means to the exposed surface of the workpiece at a predetermined angle;
a light receiving means for receiving light that is applied from the light application, passes through the inside of the workpiece and is reflected from the workpiece; and
a display means for displaying the state of light received by the light receiving means.

2. The apparatus for checking a laser processed deteriorated layer according to claim 1, which comprises a scanning-feed means for moving the light application means, the light receiving means and the workpiece holding means in a predetermined scanning-feed direction relative to one another.

3. The apparatus for checking a laser processed deteriorated layer according to claim 1, wherein the light application means irradiates an infrared laser beam.
